(19) United States
(12) Patent Application Publication
(10) Pub. No.: US 2021/0022384 A1
(43) Pub. Date: Jan. 28, 2021

(54) FIBRE REMOVING MACHINE CAPABLE OF REMOVING COCONUT FIBRE

(71) Applicant: Chi Wah LAU, Jackson Heights, NY (US)

(72) Inventor: Chi Wah LAU, Jackson Heights, NY (US)

(21) Appl. No.: 16/522,809

(22) Filed: Jul. 26, 2019

(51) Int. Cl. A23N 5/08

(52) U.S. Cl. CPC A23N 5/08

(57) ABSTRACT

A fibre removing machine capable of removing coconut fibre has a plurality of fibre removing units; wherein any two adjacent fibre removing units are spaced apart from each other by a distance to form a fibre removing space; two ends of the fibre removing space correspond to a feeding port and a discharging port, respectively; a driving device drives the fibre removing units to rotate, so that the metal bristles of the fibre removing units are able to go into and out of the fibre removing space repeatedly. Thus, after a husk-removed coconut is put in the feeding port, the coconut passes through the fibre removing space, and is transported out via the discharging port, and then the metal bristles will repeatedly scrape off the coconut fibres of the coconut while the transportation process.

### BACKGROUND OF THE INVENTION

### Field of the Invention

The present disclosure relates to a fibre removing machine; in particular, to a fibre removing machine capable of removing coconut fibre (also called “coir”).

### Description of Related Art

In recent years, coconuts have become increasingly popular. In particular, natural coconut water is regarded as one of the best drinks during exercise. In Hawaii, coconut water is called “noelani”, which means the dews from the sky. Coconut water is rich not only in natural vitamins (especially vitamin B group), which are indispensable elements for body cells to complete their reactions, but also in minerals and trace elements (including zinc, selenium, iodine, sulfur, and manganese), and also a good source of abundant amino acids, organic acids, antioxidants, electrolytes and natural salts.

Further, the taste and sweetness of coconut water is almost similar to that of most juices, while its sugar content is much less than that of most juices. Furthermore, coconut water contains almost no fat, which is an important factor for the popularity of coconut water. According to researches, drinking coconut water can have the following benefits:

(1) Lowering cholesterol. Regular consumption of coconut water can effectively lower the level of low-density lipoprotein (LDL), and also increase the level of high-density lipoprotein (HDL), reducing the risks of stroke, heart attack and high blood pressure.

(2) Controlling blood sugar. Since coconut water has low sugar content and anti-oxidation effects, it can help lower blood sugar, and is also suitable for diabetic patients.

(3) Improving digestion. Since coconut water contains a small amount of fibre, it can improve digestion and reduce bloating.

(4) Acting as a good replenishing liquid for the body. Natural coconut water is rich in vitamins and minerals (such as potassium, calcium, sodium, magnesium, etc.), so it helps to replenish the electrolytes and water needed by the body.

(5) Preventing early aging. The antioxidants contained in coconut water protect the skin from oxidation. Further, one of the most important nutrients in coconut water is cytokinin, whose nutritional value, in terms of early aging prevention, even exceeds that of electrolytes, vitamins, minerals and amino acids, as it has anti-aging effects on human cells and tissues.

(6) Relieving mouth ulcer. Coconut juice is rich in lauric acid, which has antiviral, antifungal, antibacterial and anti-inflammatory properties, and can form a chemical barrier layer in the oral cavity, which helps to recover wounds and ameliorate the symptoms of mouth ulcers.

In addition, coconut oil and coconut meat also have many benefits. For example, coconut oil contains decanoic acid, palmitic acid, oleic acid, lauric acid, fatty acids, free fatty acids (FFAs) and a variety of sterols. The above-mentioned components have the effects of supplying body nutrition, beautifying skin, and facilitating the prevention and treatment of skin diseases. Further, coconut meat is rich in proteins and carbohydrates, contains lauric acid, which helps to defend the body against bacteria, viruses and even gastrointestinal parasites, and has high dietary value.

Nevertheless, to benefit from the many advantages provided by coconuts, coconuts must first be processed, as many manufacturers have been doing. Generally speaking, as shown in FIG. 1, the structure of a coconut, from outside to inside, can be divided into coconut husk C1, coconut fibre (also called “coir”) C2, coconut shell C3, coconut meat C4 and coconut water C5. When a dealer's merchandise includes only coconut water C5, in order to facilitate transportation, the dealer usually removes coconut husk C1 first, and then manually grinds off coconut fibre C2, leaving only coconut shell C3, coconut meat C4 and coconut water C5 (collectively, often referred to as “Kopyor”). However, the aforementioned process not only costs a great deal of operating time, but also incurs high labor costs. More importantly, during the grinding process, a grinder inhales a large amount of fibre debris into his or her lungs, which seriously affects the grinder's health. In addition, it is difficult to maintain good quality by manually removing coconut fibre C2. Therefore, one important subject faced by the present disclosure is effectively solving the above problems.

### SUMMARY OF THE INVENTION

In one aspect, the present disclosure provides a fibre removing machine configured to remove coconut fibres of a coconut. The fibre removing machine includes a machine body, a plurality of fibre removing units and a driving device. The machine body has a feeding port thereon that is configured to feed a husk-removed coconut into the fibre removing machine, a discharging port thereon that is configured to discharge the coconut out of the fibre removing machine, and an accommodating space therein. The fibre removing units are located in the accommodating space, each being spaced apart from another adjacent fibre removing unit by a fibre removing space that has a first end and a second end. Each of the fibre removing units includes a rod and a plurality of metal bristles. The metal bristles are arranged on a surface of the rod, and configured to repeatedly scrape off the coconut fibres of the coconut, so as to replace the traditional manual coconut fibre grinding. The driving device is configured to drive each of the fibre removing units to rotate so that each of the metal bristles goes into and out of the fibre removing space repeatedly. The fibre removing machine is configured to transport the coconut from the first end to the second end, and the feeding port and the discharging port are located at the first and second ends of the fibre removing space, respectively.

### BRIEF DESCRIPTION OF THE DRAWINGS OF THE INVENTION

FIG. 1 is a schematic cross-sectional view of a known coconut:

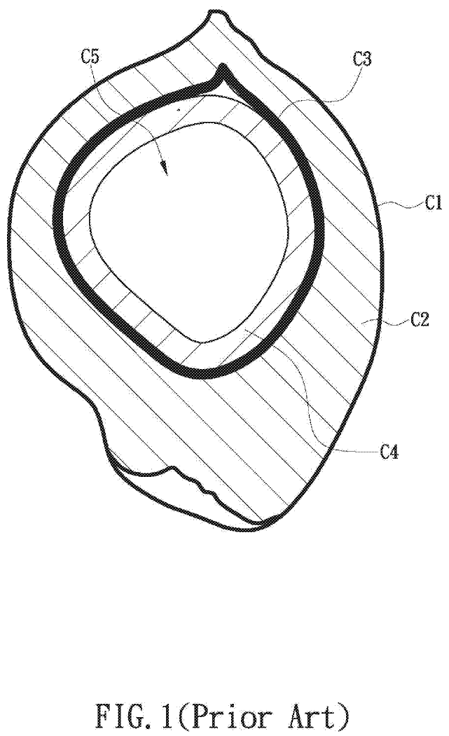

FIG. 2 is a perspective view of a fibre removing machine according to the present disclosure;

FIG. 3 is another perspective view of the fibre removing machine according to the present disclosure;

FIG. 4 is a schematic view of fibre removing units according to the present disclosure; and

FIG. 5 is an elevation view of the three fibre removing units according to the present disclosure.

### DETAILED DESCRIPTION OF THE DRAWINGS OF THE INVENTION

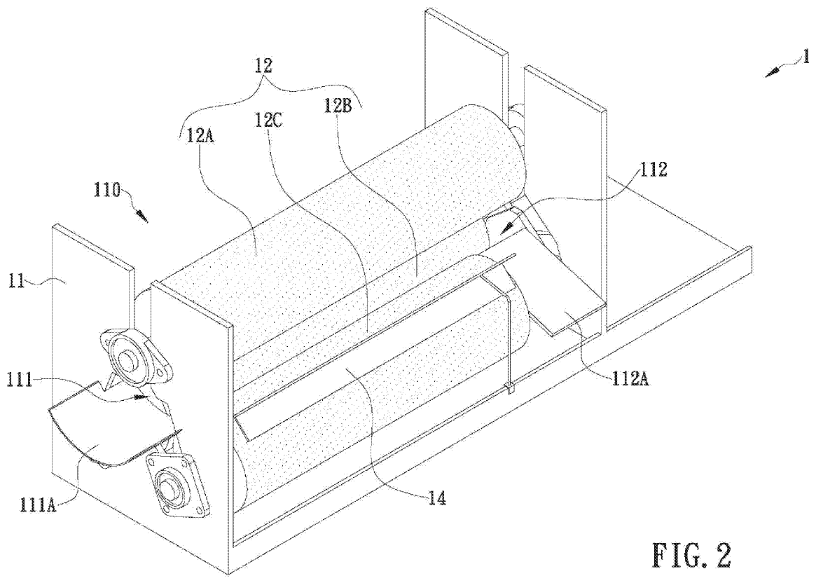

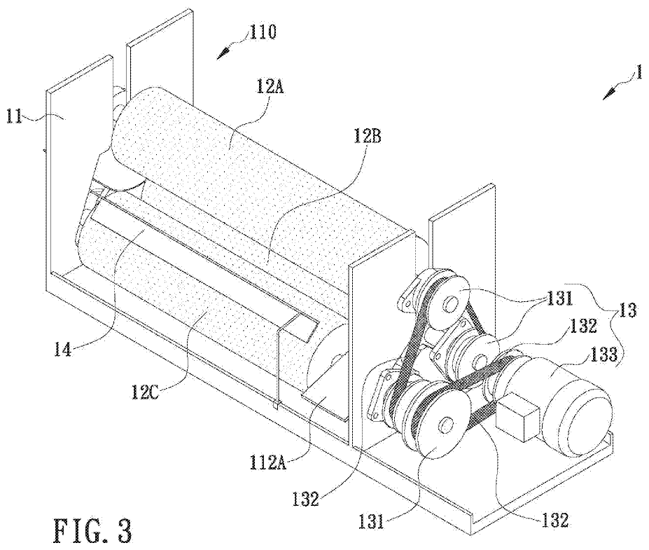

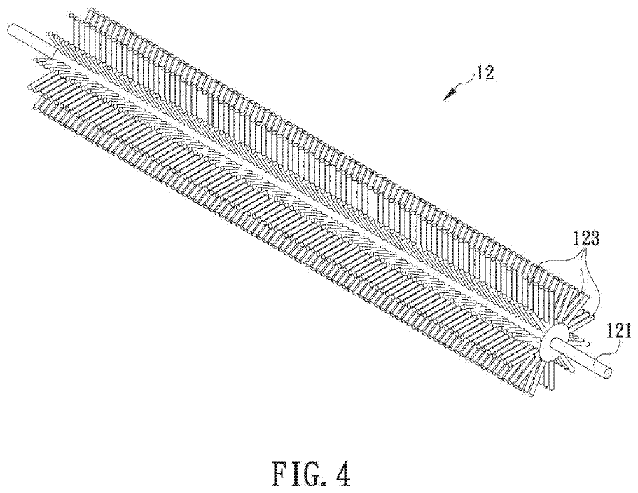

The present disclosure is related to a fibre removing machine capable of removing coconut fibre. In certain embodiments, as shown in FIGS. 2 and 3, the fibre removing machine 1 includes a machine body 11, a plurality of fibre removing units 12 and a driving device 13. A feeding port 111 and a discharging port 112 are provided on the machine body 11, and an accommodating space 110 is arranged in the machine body 11. It is noted that the appearance of the machine body 11 is not limited to that shown in FIG. 2. In actual production, the appearance of the machine body 11 can be adjusted by a manufacturer according to product requirements, and in certain embodiments, even to the extent that the fibre removing units 12 are not exposed as shown in FIG. 2, but being covered by and sealed within the machine body 11. Further, the fibre removing units 12 shown in FIGS. 2 and 3 are for illustration purpose only, and the detailed structure of the fibre removing units 12 is shown in FIG. 4.

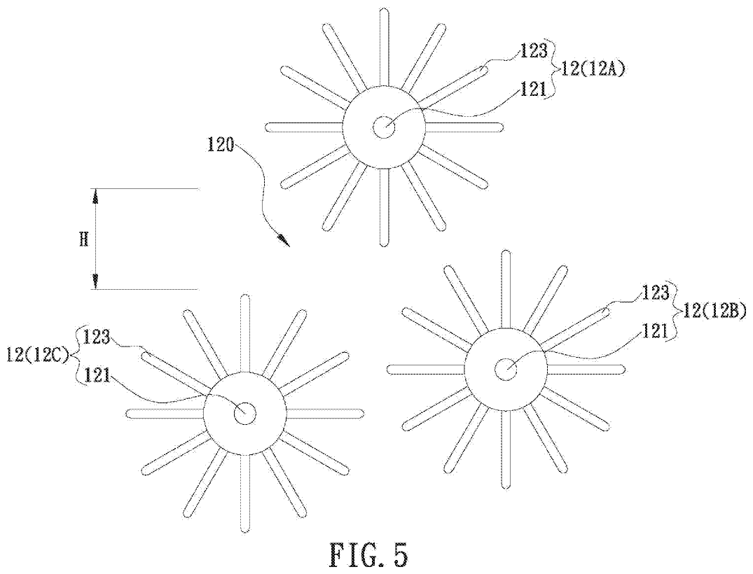

Referring to FIGS. 2, 4 and 5, in certain embodiments, the fibre removing units 12 are located in the accommodating space 110. As shown in FIG. 4, Each fibre removing unit 12 includes at least one rod 121 and a plurality of metal bristles 123. In certain embodiments, the surface of each rod 121 is arranged with the metal bristles 123, and as shown in FIG. 5, each fibre removing unit 12 is spaced apart from another adjacent fibre removing unit 12 to form a fibre removing space 120 therebetween. The feeding port 111 is located at one end of the fibre removing space 120, and the discharging port 112 is located at the other end of the fibre removing space 120. In certain embodiments, the fibre removing units 12 includes a first fibre removing unit 12A, a second fibre removing unit 12B, and a third fibre removing unit 12C. However, the number of the fibre removing units 12 is not limited to three. The position of the first fibre removing unit 12A in the accommodating space 110 is higher than that of the second fibre removing unit 12B and the third fibre removing unit 12C, while the position of the second fibre removing unit 12B can be slightly higher than or close to that of the third fibre removing unit 12C. The position difference between the fibre removing units 12 can be caused either by the rod 121 of the second fibre removing unit 12B being installed higher than the rod 121 of the third fibre removing unit 12C, or by the second fibre removing unit 12B having metal bristles 123 whose length is greater than that of the metal bristles 123 of the third fibre removing unit 12C. However, in certain embodiments, the second fibre removing unit 12B and the third fibre removing unit 12C's heights above the bottom of the accommodating space 110 can still be the same, as long as the positions of the second fibre removing unit 12B and the third fibre removing unit 12C, which are lower than that of the first fibre removing unit 12A, are arranged in such a way that is sufficient to carry the coconut that enters the fibre removing space 120.

Referring to FIG. 2 to FIG. 5, the driving device 13 is located on the machine body 11, and is configured to drive each of the fibre removing units 12 to rotate. In certain embodiments, the driving device 13 includes a plurality of driving reels 131, a plurality of driving members 132, for example, belts, chains, gears, etc., and a motor unit 133. One end of each of the rod 121 can be assembled with one of the driving reels 131, and each of the driving members 132 is winded on two driving reels 131 that are adjacent to each other. The output shaft of the motor unit 133 can be assembled to one of the driving reels 131, so that after the motor unit 133 is actuated, the motor unit 133 can drive each of the driving members 132 and the driving reels 131, and drive each of the rods 121 to rotate. Further, when the rods 121 rotate, the metal bristles 123 thereon go into and out of the fibre removing space 120 repeatedly. However, the present disclosure is not limited to the afore-mentioned description, and in certain embodiments, the components of the driving device 13 may be adjusted by manufacturers according to product demands, as long as the driving device 13 can drive each of the fibre removing units 12 to rotate.

Referring again to FIGS. 2-5, an operator may first remove the husk of a coconut, and then place the husk-removed coconut at the feeding port 111. The coconut would then fall to one end of the fibre removing place 120, be transported from the end to the other end of the fibre removing place 120, and be transported out of the machine body 11 via the discharging port 112. During the transportation process, with the aid of the rotation of the fibre removing units 12, the coconut fibres of the coconut is repeatedly scraped off by the metal bristles 123. Furthermore, the coconut fibre scraping force of the metal bristles 123 also forces the coconut to roll continuously, so that each part of the coconut fibres on the surface of the husk-removed coconut can be exactly scraped off by the metal bristles 123. Therefore, the fibre removing machine 1 can replace the traditional manual coconut fibre grinding, greatly lower the labor costs of coconut dealers, and shorten the overall operation time for the dealers.

Referring again to FIG. 2 to FIG. 5, in certain embodiments, the fibre removing units 12 are disposed in an inclined manner such that the position of one end of the fibre removing space 12 is higher than the other end of the fibre removing space 12. The inclined disposition allows the coconut to naturally roll from one end of the fibre removing space 12 toward the other end of the fibre removing space 12 due to its own weight. However, in certain embodiments, a manufacturer may also change the length of the metal bristles 123 or the inclination degree of the machine body 11, such that the position of one end of the fibre removing space 120 is higher than the position of the other end. In addition, an operator can also provide a conveyor belt in the fibre removing space 120 to transport the coconut from one end of the fibre removing space 120 to the other end.

Further, the scraping force of the metal bristles 123 applied to the coconut fibres also drives the coconut to move along a direct toward outside of the fibre removing space 120. Accordingly, in certain embodiments, as shown in FIG. 2 to FIG. 5, to avoid the coconut from falling out of the fibre removing space 120 because of the force of the metal bristles 123 or during its rolling in the fibre removing space 120, the fibre removing machine 1 further includes at least one protective rack 14. The protective rack 14 is located between the gap H between the two adjacent fibre removing units 12A and 12C, and outside of the fibre removing space 120. Therefore, when the coconut is rolling or being scraped by the metal bristles 123, the coconut can be blocked by the protective rack 14 and does not fall out of the fibre removing space 120 before reaching the discharge port 112.

Referring again to FIG. 2 to FIG. 5, in certain embodiments, a position on the fibre removing machine 1 that corresponds to the feeding port 111 is disposed with a feeding member 111A, and another position on the fibre removing machine 1 that corresponds to the discharging port 112 is disposed with a discharging element 112B. In certain embodiments, at least one of the feeding member 111A and the discharging member 112B is in the shape of a track, and can be connected with other machines that performs other processing procedures. For example, a husk removing machine can be connected to the feeding member 111A, and a machine that collects coconuts whose coconuts fibre have been removed can be connected to the discharging member 111B, so as to meet demands for automated processing.

While the invention herein disclosed has been described by means of specific embodiments, numerous modifications and variations could be made thereto by those skilled in the art without departing from the scope of the invention set forth in the claims.

1. A fibre removing machine configured to remove coconut fibres of a coconut, comprising:
a machine body having:
a feeding port thereon that is configured to feed a husk-removed coconut into the fibre removing machine;
a discharging port thereon that is configured to discharge the coconut out of the fibre removing machine; and
an accommodating space therein;
a plurality of fibre removing units located in the accommodating space, each spaced apart from another adjacent fibre removing unit by a fibre removing space having a first end and a second end, and comprises:
a rod; and
a plurality of metal bristles arranged on a surface of the rod and configured to repeatedly scrape off the coconut fibres of the coconut and a driving device configured to drive each of the fibre removing units to rotate so that each of the metal bristles goes into and out of the fibre removing space repeatedly,
wherein the fibre removing machine is configured to transport the coconut from the first end to the second end, and the feeding port and the discharging port are located at the first and second ends of the fibre removing space, respectively.

2. The fibre removing machine according to claim 1, wherein a position of one of the first and second ends is higher than the other one of the first and second ends, so that the coconut rolls from the one of the first and second ends to the other one of the first and second ends.

3. The fibre removing machine according to claim 2, wherein a number of the fibre removing units is or greater than three, a position of one of the fibre removing units is higher than positions of another two of the fibre removing units, and when the coconut is in the fibre removing space, the coconut is carried by the another two fibre removing units.

4. The fibre removing machine according to claim 3, further comprises a protective rack located out of the fibre removing space and at a gap between two adjacent ones of the fibre removing units.

5. The fibre removing machine according to claim 4, further comprises a feeding member corresponding to a position of the feeding port.

6. The fibre removing machine according to claim 5, further comprises a discharging member corresponding to a position of the discharging port.
